(19) United States
(12) Patent Application Publication
(10) Pub. No.: US 2004/0069971 A1
(43) Pub. Date: Apr. 15, 2004

(54) Polyol compositions and rigid polyisocyanurate foams prepared therefrom

(76) Inventors: Martijn M. Witteveen, Terneuzen (NL); Andrei K. Gantchev, Buhl (DE); Henri J.M. Gruenbauer, Oostburg (NL); Ronald Van Den Bosch, St. Jansteen (NL)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/272,053

(22) Filed: Oct. 15, 2002

(51) Int. Cl. C08G 18/00; C08G 18/32

(52) U.S. Cl. 252/182.13; 521/174; 528/44; 528/85

(57) ABSTRACT

A polyol composition comprising a high concentration of ethylene oxide having a functionality of from about 2 to about 8, preferably 2; a polyisocyanurate composition having an isocyanate index of from about 180 to about 450 and comprising the reaction product of a polyisocyanate and the polyol composition; a rigid polyisocyanurate foam comprising the polyisocyanurate composition; and a process for making a polyisocyanurate foam which comprises reacting a polyisocyanate with the polyol composition in the presence of a trimerization catalyst.

### BACKGROUND OF THE INVENTION

The present invention relates to polyol compositions and rigid polyisocyanurate foams prepared therefrom.

Rigid polyisocyanurate foams are known and are described, for example, in U.S. Pat. Nos. 4,607,064, 5,260,344 and 4,780,485.

Rigid polyisocyanurate foams have many known uses, such as in building materials and thermal insulation. Such foams are known to have excellent flammability performance, outstanding initial and long term thermal insulation properties and superior structural properties.

Rigid polyisocyanurate foams are usually obtained by reacting a polyisocyanate and an organic polyol in the presence of a trimerization catalyst in an amount sufficient to bring the NCO/OH equivalent ratio to about 1.8 or greater.

Current industry demands require a high level of fire resistance in rigid construction foams specifically Double Band Laminated (DBL), Rigid Faced (RF) and Flexible Faced (FF) foams. Polyester polyol-based polyisocyanurate foams are currently being used by the industry to meet these demands and strength demands as well. The current process of producing polyol-based polyisocyanurate foams involve the use of materials comprising volatile organic chemicals (VOC), such as flame retardants, catalysts and blowing agents.

A strong drive is observed towards reduction and ultimately elimination of the use of volatile organic chemicals which are perceived to negatively impact human health and environment.

WO 01/51538 discloses a polyol formulation which is free of DMPP (dimethyl methyl phosphonate) for producing rigid polyurethane foams having an isocyanate index of between 50 and 160. According to the disclosure, DMPP is prone to be emitted when the waste produced in manufacturing rigid foam laminates is recycled into press boards.

A proposed approach to the problem caused by the volatile organic chemicals in the industry segment of insulation foams covered by polyisocyanurate foams having an isocyanate above 180 is to design polyol formulations or compositions with increased water levels that allow reduction or even total elimination of volatile blowing agent by using CO₂, produced by the H₂O—NCO reaction, as the blowing agent. Unfortunately, current polyester-based technology does not allow switching to this option of “water blowing” because using water in the preparation of polyisocyanurate foams result in the formation of polyurea structures which make the surface of the foams brittle, so that adhesion between the foam and the skin is adversely affected. U.S. patent application Ser. No. 20020103268 A1 (2002) and PCT/EP93/ 01651, Bayer) describe the adverse effect of the addition of water to a polyisocyanurate foam formulation.

It has been found that polyester polyols are unstable in the presence of water due to hydrolysis of the ester linkage. It is also known that polyester polyols, which are polar, are not compatible with pentane, the primary blowing agent used in Europe in the production of polyisocyanurate foams. As used herein, the term “not compatible with pentane” means that pentane does not easily dissolve in polyester polyol. Thus, it is very difficult to design storage-stable polyol formulations when polyester polyols are present.

It would be desirable to provide polyol compositions which are suitable for use in the production of rigid polyisocyanurate foams which contain significantly lower levels of volatile materials to reduce and optionally eliminate the VOC impact on the environment while maintaining and improving superior fire retardant performance of current isocyanurate foams and other product performance requirements that are currently standard in the industry.

Polyol compositions for such foams should preferably contain reduced levels of polyester polyols to increase their storage stability.

### SUMMARY OF THE INVENTION

In a first aspect, the present invention is a polyol composition comprising a high concentration of ethylene oxide having a functionality of from about 2 to about 8, preferably 2.

In a second aspect, the present invention is a polyisocyanurate composition comprising the reaction product of a polyisocyanate and the polyisocyanate composition of the first aspect.

In a third aspect, the present invention is a rigid polyisocyanurate foam comprising the polyisocyanurate composition of the second aspect.

In a fourth aspect, the present invention is a process for preparing a polyisocyanurate composition which comprises reacting a polyisocyanate with a polyol composition comprising a high concentration of ethylene oxide having a functionality of from about 2 to about 8, more preferably 2, in the presence of a trimerization catalyst.

### DETAILED DESCRIPTION OF THE INVENTION

The present invention is a polyol composition to be foamed with polyisocyanate at a 180-450 index with the key component being a high concentration of ethylene oxide polyol (10-70 pbw).

Preferably, the first polyol is derived substantially from the addition of ethylene oxide to an initiator having a functionality of 2 to 8. More preferably, the first polyol is derived from the addition of only ethylene oxide (100% EO); however, 20% of the EO can be substituted with propylene oxide (PO). Still more preferably, the polyols contain at least 90% EO. Most preferably the polyols contain at least 95% EO.

Preferred ethylene oxide polyols are ethylene oxide diols having a molecular weight of from about 350 to about 800, more preferably from about 400 to about 700. Such diols can be produced by standard procedures known in the art. Such diols are commercially available from The Dow Chemical Company as VORANOL™ E400 and VORANOL™ E600.

The ethylene oxide polyol is typically employed in an amount of from about 10 to about 70, preferably from about 15 to about 70, more preferably from about 20 to about 60 and, most preferably, from about 25 to about 40 percent by weight of the total polyol.

Preferably, the second polyol has at least two hydroxyl groups, primary or secondary amine groups, or carboxylic acid or thiol groups, per molecule. Compounds having at least two hydroxyl groups per molecule are preferred. Typical polyols suitable for preparing polyisocyanurate foams include those having an equivalent weight of from about 30 to about 700, preferably from about 70 to about 300 and, more preferably, from about 70 to about 150. Such polyols also advantageously have a functionality of at least 2, preferably at least 3, and up to 8 active hydrogen atoms per molecule. Representative of such polyols include polyether polyols, polyhydroxy-terminated acetal resins, hydroxyl-terminated amines and polyamines. Examples of these and other suitable isocyanate-reactive materials are described more fully in U.S. Pat. Nos. 6,319,962 and 5,362,764. Preferred for preparing rigid foams, on the basis of performance, availability and cost, is a polyol prepared by adding an alkylene oxide to an initiator having from 2 to 8, preferably from 3 to 8 active hydrogen atoms. Other highly preferred polyols include alkylene oxide derivatives of Mannich condensates, as described, for example, in U.S. Pat. Nos. 3,297,597, 4,137,265 and 4,383,102; and aminoalkylpiperazine-initiated polyethers as described in U.S. Pat. Nos. 4,704,410 and 4,704,411.

The second polyol is generally present in an amount of from 5 to 70 percent by weight of the total polyol.

Although the use of the high EO containing polyol gives a polyisocyanaurate foam with good properties in the absence of a polyester polyol, polyester polyols can optionally be present in the polyol composition up to a level of 80 percent, preferably from about 15 to about 70 percent by weight of the total polyol composition, to increase the aromaticity in the foam.

Due to fire retardant properties associated with aromatic-initiated polyol, in a preferred embodiment, the polyol composition contains an aromatic-initiated polyether polyol. Such aromatic-initiated polyols include those based on toluene diisocynate (TDA). Advantageously, the aromatic-initiated polyether polyol is an alkylene oxide adduct of a phenol/formaldehyde resin, frequently called a “novolac” polyol, such as disclosed in U.S. Pat. No. 3,470,118 and 4,046,721.

The polyol composition can contain halogenated polyols which enhance the flame retardation of the final foam. These reactive compounds generally contain halogen moieties and further contain one or more reactive groups, such as —OH or —COOH, which are capable of reacting with an isocyanate moiety. Such compounds are known in the art and generally are halogenated polyols such as derivatives of phthalic acid, bisphenol A, an anhydride or an alcohol. For example, halogenated polyether-polyols are described in U.S. Pat. Nos. 4,072,638, 4,069,911 and 4,173,710. Examples of such reactive halogenated compounds include diester/ether diol of tetrabromophthalic anhydride, tetrabromobisphenol A, IXOL™ B251, a halogenated polyether polyol available from Solvay S.A., tetrabromobisphenol A-bis(allyl ether), tetrabromobisphenol A-bis(2-hydroxyethyl ether); tribromophenylmaleimide, tetrabromophthalate, dibromopentylglycol, tetrabromodipentaerythritol, tetrabromophthalic anhydride, dibromopropanol, chlorendic acid and tetrachlorophthalic anhydride. Preferably, the halogen is bromine.

The polyol composition can also contain a propylene oxide-based polyether polyol for further improving the pentane compatibility of the polyol composition.

The polyisocyanates which can be employed in the practice of the present invention can be any organic polyisocyanate having at least two free isocyanate groups. Suitable polyisocyanates include, without limitation, toluene-2,4-diisocyanate, 2,2,4-trimethylhexamethylene-1,6-diisocyanate, hexamethylene-1,6-diisocyanate, diphenylmethane-4,4-diisocyanate, triphenylmethane-4,4′, 4″-triisocyanate, polymethylene polyphenylisocyanate, m-phenylene diisocyanate, p-phenylene diisocyanate, 2,6-toluene diisocyanate, 1,5-naphthalene diisocyanate, naphthalene-1,4-diisocyanate, diphenylene-4,4′-diisocyanate, 1,4-cyclohexylene dimethylene diisocyanate, xylene-1,4-diisocyanate, xylene-1,3-diisocyanate, cyclohexyl-1,4-diisocyanate, 4,4′-methylene-bis(cyclohexyl isocyanate), 3,3′-dimethyldiphenylmethane-4,4′-diisocyanate, isophorone diisocyanate, m-tetramethyl xylene diisocyanate, the product obtained by reacting trimethylol propane and 2,4-toluene diisocyanate in a ratio of 1:3, isocyanurate and biruet adducts of hexamethylene-1,6-diisocyanate and the like. Preferred isocyanates are methylene-bridged polyphenl polyisocyanates and mixtures thereof with crude diphenylmethane diisocyanate.

The polyisocyanate is employed in the practice of the present invention at an isocyanate index of from about 1.8 to about 10, preferably from about 2 to 5, most preferably from about 2.5 to about 3.5. As used herein, the term “isocyanate index” refers to the ratio of equivalents of isocyanate groups over the number of equivalents of isocyanate reactive groups present in the polyol composition.

The polyisocyanates are commercially available from The Dow Chemical Company or can be produced by procedures known in the art.

The trimerization catalysts which can be employed in the practice of the present invention includethe quaternary ammonium compounds such as benzyl trimethylammonium hydroxide, the N-hydroxypropyl trimethylammonium salt of formic acid and other onium compounds, alkali metal hydroxides such as potassium hydroxide, the alkali metal alkoxides such as sodium methoxide, the alkali metal acid salts of carboxylic acids, particularly the saturated aliphatic monocarboxylic acids having from 2 to 12 carbon atoms, such as sodium acetate, potassium acetate, potassium 2-ethylhexoate, potassium adipate and sodium benzoate; various tertiary amines such as trimetholamine, triethylamine, tetramethyl guanidine, 2,4,6-tris(trimethylaminomethyl)phenol, triethylene diamine and N,N,N′,N′-tetramethyl, 1,3-butane diamine; the non-basic metal salts of a carboxylic acid such as lead octate and the like. Mixtures of two or more of said trimerization catalysts or mixtures of one or more of said catalysts with a compound which is not specifically capable of catalyzing the trimerization of an isocyanate to a substantial extent can be employed. For example, although a catalyst such as a triazine derivative is capable of catalyzing both the trimerization reaction and the formation of urethane bonds by the reaction of the isocyanate with an active hydrogen-containing compound and requires no auxillary urethane catalyst. Trimerization catalysts which are not specifically capable of catalyzing the reaction between the polyisocyanate and the active hydrogen-containing compound are preferably employed in combination with a material which catalyzes the reaction of an isocyanate with an active hydrogen-containing compound, preferably the aliphatic tertiary amines such as 1,4-diazobicyclo(2,2,2)octane and N,N-dimethyl amine and the organic tin compounds are employed in combination with the trimerization catalyst. The preferred catalyst system comprises a quaternary ammonium compound, an alkali metal acid salt and a catalyst specifically capable of catalyzing the reaction of an isocyanate with an active hydrogen-containing compound.

The amount of trimerization catalyst most advantageously employed herein is dependent on a variety of factors including the specific polyisocyanate employed and the effectiveness of the particular catalyst or catalyst system employed. In general, the trimerization catalyst(s) is employed in amounts of from 0.5 to 8, preferably from 0.7 to 5, weight percent based on the weight percent of the active hydrogen-containing compounds. If employed, the catalyst specifically used to catalyze the reaction of the isocyanate with the active hydrogen-containing material is employed in amounts from 0.1 to 30 weight percent based on the total weight of the active hydrogen-containing compounds. In the preferred catalyst system, the quaternary ammonium compound is employed in an amount from 0.5 to 5, preferably from 0.7 to 3, weight percent; the alkali metal acid salt in an amount from 0.5 to 3, preferably from 0.6 to 2, weight percent and the catalyst specifically employed to catalyze the reaction of the isocyanate with the active hydrogen-containing components in an amount from 0.1 to 3 weight percent, said weight percents being based on the total weight of the active hydrogen-containing compounds.

Although this invention is not limited by any theory, it is believed that the high EO concentrations in these systems provide additional driving force for trimerization reaction due to the higher flexibility of their molecular chains, which leads to the formation of more trimers than when a polyester polyol is used. More trimers provide the polyisocyanurate foams with better flammability properties.

Although not required, one or more catalysts for the reaction of the polyol and water with the polyisocyanate can be used to enhance the reaction profile of the system. Any suitable urethane catalyst may be used, including tertiary amine compounds and organometallic compounds. Exemplary tertiary amine compounds include triethylenediamine, N-methylmorpholine, N,N-dimethylcyclohexylamine, pentamethyldiethylenetriamine, tetramethylethylenediamine, 1-methyl-4-dimethylaminoethylpiperazine, 3-methoxy-N-dimethylpropylamine, N-ethylmorpholine, diethylethanolamine, N-cocomorpholine, N,N-dimethyl-N′,N′-dimethyl isopropylpropylenediamine, N,N-diethyl-3-diethylaminopropylamine and dimethylbenzylamine. Exemplary organometallic catalysts include organomercury, organolead, organoferric and organotin catalysts, with organotin catalysts being preferred among these. Suitable tin catalysts include stannous chloride, tin salts of carboxylic acids such as dibutyltin di-laurate, as well as other organometallic compounds such as are disclosed in U.S. Pat. No. 2,846,408. Typical amounts are 0.1 to 3 parts of catalyst per 100 parts by weight of total polyol. In making polyisocyanurate foams, it is generally highly preferred to employ a minor amount of a surfactant to stabilize the foaming reaction mixture until it cures. Such surfactants advantageously comprise a liquid or solid organosilicone surfactant. Other, less preferred, surfactants include polyethylene glycol ethers of long-chain alcohols, tertiary amine or alkanolamine salts of long-chain alkyl acid sulfate esters, alkyl sulfonic esters and alkyl arylsulfonic acids. Such surfactants are employed in amounts sufficient to stabilize the foaming reaction mixture against collapse and the formation of large, uneven cells. Typically, 0.2 to 3 parts of the surfactant per 100 parts by weight polyol are sufficient for this purpose.

Additives such as blowing agents, flame retardants, fillers, pigments and the like can be used in preparing the polyisocyanurate composition of the present invention. The use of such additives is well known in the art, and reference is made thereto for the purposes of this invention.

Blowing agents which can be employed in the practice of the present invention include the hydrocarbon blowing agents which are vaporizable under foam forming conditions. Suitable hydrocarbon blowing agents include butane, isobutane, isopentane, n-pentane, cyclopentane, 1-pentene, n-hexane, iso-hexane, 1-hexane, n-heptane, isoheptane, and mixtures thereof. Preferably the hydrocarbon blowing agent is isopentane, n-pentane, cyclopentane or mixtures thereof.

The hydrocarbon blowing agent should be used in an amount of from about 2% to about 20% and preferably from about 4% to about 15% by weight based on the weight of the entire reaction system.

Other physical blowing agents such as vaporizable non-hydrocarbons may also be used in the present invention in combination with the hydrocarbon blowing agents. Suitable blowing agents include 1,1,1,3,3-pentafluoropropane (HFC-245fa), 1,1,1,2-tetrafluorethane (HFC-134a), 11-difluoroethane (HFC-152a), difluoromethane (HFC-32), chlorodifluoromethane (HCFC-22), and 2-chloropropane, 1,1,1,3,3-pentafluoropropane (HFC 365mfc), 1,1,1,2,3,3,3-heptafluoropropane (HFC 277) 2,2,4,4-tetraflourobutane and 1,1,1,3,3,3-hexafluoropropane. When used, these blowing agents may be mixed into the isocyanate-reactive component, the isocyanate component and/or as a separate stream to the reaction system.

Water reacts with isocyanate under foam forming conditions to liberate CO₂. Water could be used with any of the physical blowing agents specified previously in an amount of between 0-5 parts by weight of the polyol depending on isocyanate index and the co-blowing agent used.

Together with CO₂ blowing, either via physical blowing or, preferably, from the isocyanate-H2O reaction, the blowing agents are employed in an amount sufficient to give the resultant foam the desired density of from about 10 to about 60 kg/m³, 60 kg/m³ preferably from about 25 to about 45 kg/m3, most preferably from about 25 to about 45 kg/m³.

Flame retardants which can be employed in the practice of the present invention include the standard flame retardants used in the production of rigid/polyisocyanurate foam such as phosphonate esters, phosphate esters, halogenated phosphate esters or a combination thereof.

Phosphonate esters can be represented by the formula R—P(O) (OR′) (OR″) where R, R′ and R″ are each independently an alkane with 1 to 4 carbon atoms. Preferred members of this group are dimethyl methylphosphonate (DMMP) and diethyl ethylphosphonate (DEEP).

Phosphate esters include trialkyl phosphates, such as triethyl phosphate, and tricresyl phosphate.

When used, the phosphonate or phosphate ester flame retardants are present in the final foam at a level of from 0.5 to 10 percent by weight of the final foam. Preferably they are 1 to 8.5 percent by weight of the final foam. More preferably they constitute 2 to 6.5 percent by weight of the final foam.

Halogenated phosphate esters which are associated with fire retardation are known in the art and can be represented by the general formula P(O) (OR′X′ₙ) (OR″X″ₙ) (OR′″X′″ₙ), where R′, R″, and R′″ are each independently an alkane with 1 to 4 carbon atoms, X′, X″ and X′″ are each independently a halogen and n is an integer from 1 to 3.

Examples of halogenated phosphate esters include 2-chloroethanol phosphate (C₆H₁₂Cl₂O₄P); 1-chloro-2-propanol phosphate [tris(1-chloro-2-propyl) phosphate] (C₉H₁₈Cl₃O₄P) (TCPP); 1,3-Dichloro-2-Propanol Phosphate (C₉H₁₅Cl₆O₄P) also called tris(1,3-dichloro-2-propyl) phosphate; tri(2-chloroethyl) phosphate; tri (2,2-dichloroisopropyl) phosphate; tri (2,3-dibromopropyl) phosphate; tri(1,3-dichloropropyl)phosphate; tetrakis(2-chloroethyl)ethylene diphosphate; bis(2-chloroethyl) 2-chloroethylphosphonate; diphosphates [2-chloroethyl diphosphate]; tetrakis(2-chloroethyl) ethylenediphosphate; tris-(2-chloroethyl)-phosphate, tris-(2-chloropropyl)phosphate, tris-(2,3-dibromopropyl)-phosphate, tris(1,3-dichloropropyl)phosphate tetrakis (2-chloroethyl-ethylene diphosphate and tetrakis(2-chloroethyl) ethyleneoxyethylenediphosphate.

Tribromoneopentyl chloroalkyl phosphates as disclosed in EP 0 735 039 having the formula [(BrCH₂)₃C—CH₂)]ₘPO (OCYHCH₂Cl)₃₋ₘ where Y represents a hydrogen, an alkyl, having 1 to 3 carbon atoms, or chloroalkyl group and m is from 0.95 to 1.15 may also be used.

When used as a flame retardant, the halogenated phosphate ester will comprise at least 1 percent by weight of the final foam, preferably at least 2 percent by weight of the final foam and more preferably at least 4.5 percent by weight of the final foam. The halogenated phosphate ester generally does not exceed 9 percent by weight of the final foam, preferably 8 percent or less of the final foam and more preferably less than 6.5 percent by weight of the foam.

Pigments and fillers which can be employed in the practice of the present invention include carbon black, titanium dioxide, graphite, iron oxide, calcium carbonate, alum, clays such as kaolin or wollastinite, chopped glass fibers, continuous glass fibers, flaked glass, polyester and other polymeric fibers and the like.

The rigid polyurethanes in accordance with the present invention are readily prepared according to standard procedures in the art which bring together under foam-forming conditions the polyisocyanate, active hydrogen-containing material, the blowing agent, surfactant and other foam-forming ingredients, at a temperature of from 10° C. to 80° C. Any order of mixing is acceptable.

In general, the rigid foams are produced by discontinuous or continuous processes, including what is regarded as the discontinuous panel process (DCPP) and double ban laminates (DBL), with the foaming reaction and subsequent curing being carried out in molds or on conveyors. When utilizing the foams in laminates, the facing may be flexible, for example, aluminum foil or coated paper, or may be made with a rigid material such as plaster-board, polyester facing or steal facing. Other processes to prepare construction foams are known as spray and block foams.

The polyisocyanurate composition of this invention can be prepared from the aforedescribed components using well known methods.

The polyisocyanurate composition of this invention is useful in the preparation of rigid construction foams such as Double Band Laminated (DBL), Rigid Faced (RF) and Flexible Faced (FF) foams, pipe insulations and the like.

The following working examples are given to illustrate the invention and should not be construed as limiting its scope. Unless otherwise indicated, all parts and percentages are by weight.

### EXAMPLES

The following materials/abbreviations are used in the Examples:

| | |
|---|---|
| CP 1421 | Polyether polyol based on glycerine and propylene |
| | oxide |
| B 8469 | Silicone surfactant |
| CT | Cream Time |
| Curithane 206 | Catalyst, Potassium acetate (33% active in |
| | Diethylene Glycol (DEG) |
| Dabco K-15 | Catalyst, Potassium octoate |
| DC 193 | Silicone surfactant |
| DEEP | Flame retardant, Diethyl ethyl phosphonate |
| DMCHA | Catalyst, Dimethyl cyclohexyl amine |
| E400 | Ethoxylated DEG with a molecular weight of 440/mol |
| E600 | Ethoxylated DEG with a molecular weight of |
| | 600 g/mol |
| GT | Gel Time |
| IP 585 | Novolac-initiated polyol |
| M 590 Iso | PMDI Isocyanate |
| MEG | Mono ethylene glycol |
| PMDI | Polymeric diphenylmethane diisocyanate |
| PS 2352 | PA-based polyester polyol |
| Repol 209-24 | PET-based polyester polyol |
| PA 640 | Amine-initiated polyol |
| TCPP | Flame retardant, Trimonochloropropyl phosphate |
| TEP | Flame retardant, Triethyl phosphate |
| TFT | Tack Free Time |
| TMR | Catalyst, 2 hydroxypropyl trimethyl ammonium 2- |
| | ethylhexoate (75% active in MEG) |
| Terate 2541 | Dimethyl terephthalate-based polyester polyol |
| V 504 | Surfactant based on ethylene oxide and butylene |
| | oxide |

### Test Procedures

### The Handmix Procedure

(1) Weigh the required amount of Isocyanate in a paper cup and insert a thermometer;

(2) Weigh the required ingredients of the polyol blend in another paper cup and add an excess blowing agent;

(3) Stir the polyol blend at 1500 rpm (sometimes another speed is required);

(4) Move the cup downwards, so the stirrer can rotate freely in the cup;

(5) Maintain the temperature of the blend and the isocyanate at 20±0.5° C.;

(6) Weigh the cup with the blend again and when necessary add blowing agent to compensate the evaporated amount of blowing agent;

(7) Repeat the last four actions until the desired final weight and temperature is reached;

(8) Add the isocyanate to the polyol blend and stir;

(9) Pour the mix into a carton box; and

(10) Measure and write down:

| | |
|---|---|
| Cream time: | time period between start of stirring and |
| | beginning of foam rise, characterized by |
| | a color change of the mix. |
| Gel time: | time period between start of stirring and |
| | start of gelation. Introduce a probe in |
| | the foaming mass and lift it up from time |
| | to time. Gelation has started when the |
| | foaming mass sticks to the probe and |
| | starts to pull strings of material. |
| Tack free time: | time period between start of stirring and |
| | the moment when the top surface of the |
| | foam looses it adhesiveness. |

### Adhesion

Laboratory scale size assessment of adhesion values of rigid Polyurethanes foam intended only for the purpose of assessing quick and simple a relative value for the adhesion of a handmix foam to its carton box.

(1) Three minutes after mixing the reacting components, pull at the sides of the carton box in which the foam was formed;

(2) Assign a number between 0 and 5 to indicate the adhesion values of the foam (0 indicates no adhesion, 5 indicates a very good adhesion).

A very good adhesion is indicated when the carton side is impossible to remove by hand.

No adhesion is indicated when the carton side can be removed by hand with a minimum force.

### Friability

A foam is made using steps (1) to (9) of the handmix technique described above. Ten minutes after the initial mixing, the cure of the skin of the foam is determined.

The brittleness of the foam is then determined by pressing on the surface of the foam.

When one hears a cracking noise and when the skin feels crunchy, the foam is brittle/friable.

Numbers 0 to 5 are assigned to indicate the friability of the foams: 0-very brittle/friable; 5-not brittle/friable.

### Bottom Disturbances

A handmix is made in a carton box. After foaming, the carton is removed and the bottom of the foam is inspected. A number of 0-5 is assigned to the amount of voids (disturbances) that appear on the bottom of the foam. A “0” indicates a lot of voids (bottom disturbance) on the bottom of the foam; a “5” indicates that the foam surface does not have voids (bottom disturbances).

### Examples 1-4

Four series of polyol blends were prepared. The formulations are given in Tables 1 and 2. Foams and foam laminates were made from these formulations.

Example 1 demonstrates that a polyether polyol (E400 and E600) do not degrade under the influence of water when stored in a blend, whereas polyester polyols do. The data in Table 3 show thatafter a prolonged storage time at high temperatures, Polyester formulations (1, 2, and 3) degrade and Polyether formulations (4 and 5) do not.

Examples 2-4 demonstrate that all foams made with polyether polyol gave better adhesion and friability ratings than the polyester counterparts; polyether formulations need less amine-catalyst. The data are shown in Tables 4-6.

TABLE 1
Formulations Of Equal Reactivity
Polyol/Water and Additives separated

| | | R P 2 | R P 3 | | |
|---|---|---|---|---|---|
| | R P 1 | Terate | Repol | R P 4 | R P 5 |
| Components | Ps 2352 | 2541 | 209-24 | E 600 | E 400 |
| Polyol | 89.10 | 89.09 | 89.09 | 92.09 | 90.78 |
| H2O | 4.39 | 4.42 | 4.42 | 3.81 | 4.83 |
| Total | 93.49 | 93.51 | 93.51 | 95.90 | 95.61 |
| | R A 1 | R A 2 | R A 3 | R A 4 | R A 5 |
| B 8469 | 0.50 | 0.50 | 0.50 | 0.50 | 0.50 |
| V 504 | 1.50 | 1.50 | 1.50 | 1.50 | 1.50 |
| TMR | 2.00 | 2.00 | 2.00 | 1.50 | 1.25 |
| K 15 | 1.50 | 1.50 | 1.50 | 0.50 | 1.00 |
| DMCHA | 1.00 | 1.00 | 1.00 | 0.10 | 0.16 |
| Total | 6.50 | 6.50 | 6.50 | 4.10 | 4.41 |
| Total Polyol | 100 | 100 | 100 | 100 | 100 |
| ISO M 600 | 306 | 309 | 309 | 253 | 347 |
| H2O index (Mol | 0.601 | 0.600 | 0.600 | 0.600 | 0.600 |
| water/kg foam) | | | | | |
| ISO index | 2.507 | 2.500 | 2.500 | 2.500 | 2.503 |
| (Mol/Mol) | | | | | |

Polyol/Water and Additives combined

| | R C 1 | R C 2 | R C 3 | R C 4 | R C 5 |
|---|---|---|---|---|---|
| Polyol | RP1 + RA1 | RP2 + RA2 | RP3 + RA3 | RP4 + RA4 | RP5 + RA5 |
| ISO M 600 | 306 | 309 | 309 | 253 | 347 |

TABLE 2
Formulations Of Equal Concentration
Polyol/Water and Additives separated

| | | R P 2 | R P 3 | | |
|---|---|---|---|---|---|
| | C P 1 | Terate | Repol | C P 4 | C P 5 |
| Components | Ps 2352 | 2541 | 209-24 | E 600 | E 400 |
| Polyol | 90.57 | 90.57 | 90.57 | 90.57 | 90.57 |
| H2O | 4.43 | 4.43 | 4.43 | 4.43 | 4.43 |
| Total | 95.00 | 95.00 | 95.00 | 95.00 | 95.00 |
| | C A 1 | C A 2 | C A 3 | C A 4 | C A 5 |
| B 8469 | 0.50 | 0.50 | 0.50 | 0.50 | 0.50 |
| V504 | 1.50 | 1.50 | 1.50 | 1.50 | 1.50 |
| TMR | 1.00 | 1.00 | 1.00 | 1.00 | 1.00 |
| K 15 | 1.50 | 1.50 | 1.50 | 1.50 | 1.50 |
| DMCHA | 0.50 | 0.50 | 0.50 | 0.50 | 0.50 |
| Total | 5.00 | 5.00 | 5.00 | 5.00 | 5.00 |
| Total Polyol | 100 | 100 | 100 | 100 | 100 |
| ISO M 600 | 310 | 310 | 310 | 310 | 310 |
| H2O index | 0.600 | 0.600 | 0.600 | 0.600 | 0.600 |
| (Mol/kg) | | | | | |
| ISO index | 2.533 | 2.510 | 2.510 | 2.814 | 2.341 |
| (Mol/Mol) | | | | | |

Polyol/Water and Additives combined

| | C C 1 | C C 2 | C C 3 | C C 4 | C C 5 |
|---|---|---|---|---|---|
| Polyol | CP1 + CA1 | CP2 + CA2 | CP3 + CA3 | CP4 + CA4 | CP5 + CA5 |
| ISO M 600 | 310 | 310 | 310 | 310 | 310 |

TABLE 3

| Temp (° C.) | | | | | | |
|---|---|---|---|---|---|---|
| Age | 21 | 21 | 21 | 50 | 21 | 50 |
| (days) | 0 | 3/4 | 21/31 | 21 | 59 | 59 |
| Tack Free | TFT | TFT | TFT | TFT | TFT | TFT |
| Time¹ | | | | | | |
| RP | | | | | | |
| Series² | | | | | | |
| RP 1 | 72 | 78 | 73 | 60 | 76 | 60 |
| RP 2 | 72 | 99 | 82 | 86 | 80 | 74 |
| RP 3 | 76 | 98 | 97 | 108 | 82 | 105 |
| RP 4 | 59 | 79 | 84 | 68 | 67 | 62 |
| RP 5 | 79 | 77 | 76 | 70 | 65 | 68 |
| RC | | | | | | |
| Series³ | | | | | | |
| RC 1 | | 83 | 81 | 210 | 90 | 240 |
| RC 2 | | 107 | 120 | 223 | 180 | 300 |
| RC 3 | | 110 | 135 | 255 | 150 | 600 |
| RC 4 | | 82 | 65 | 76 | 67 | 75 |
| RC 5 | | 74 | 76 | 72 | 66 | 71 |
| CP | | | | | | |
| Series⁴ | | | | | | |
| CP 1 | 110 | 120 | 75 | 188 | 90 | 150 |
| CP 2 | 130 | 142 | 141 | 150 | 150 | 224 |
| CP 3 | 130 | 123 | 154 | 160 | 160 | 300 |
| CP 4 | 55 | 60 | 48 | 60 | 47 | 56 |
| CP 5 | 40 | 40 | 33 | 41 | 44 | 42 |
| CC | | | | | | |
| Series⁵ | | | | | | |
| CC 1 | | 135 | 117 | 300 | 150 | 360 |
| CC 2 | | 180 | 140 | 600 | 230 | 600 |
| CC 3 | | 170 | 162 | 600 | 300 | 600 |
| CC 4 | | 61 | 47 | 60 | 52 | 55 |
| CC 5 | | 44 | 33 | 28 | 35 | 40 |

¹TFT (SEC): Tack Free Time, Time at which surface is dry and does no longer adhere upon touching.
²RP: In this series all 5 blends are made to have an initial Reactivity of approximately 15/35/60 (CT/GT/TFT). Water and Polyol are stored together, but separate from water, catalyst and surfactant. The blends are stored both at high (50° C.) and room temperature (21° C.).
³RC: In this series all 5 blends are made to have an initial Reactivity of approximately 15/35/60 (CT/GT/TFT). Water, Polyol, Catalyst and surfactant are all stored in 1 blend. The blends are stored both at high (50° C.) and room temperature (21° C.)
⁴CP: In this series all 5 blends are made at equal initial component Concentrations. Water and Polyol are stored together, but separate from water, catalyst and surfactant. The blends are stored both at high (50° C.) and room temperature (21° C.)
⁵CC: In this series all 5 blends are made at equal initial component Concentrations. Water, Polyol, Catalyst and surfactant are all stored in 1 blend. The blends are stored both at high (50° C.) and room temperature (21° C.)

TABLE 4

| | | | | | | 3 days aging at | | | | | 4 days aging at | | | | |
|---|---|---|---|---|---|---|---|---|---|---|---|---|---|---|---|
| | Fresh | | | | | 21° C. | | | | | 21° C. | | | | |
| | R | R | R | R | R | R | R | R | R | R | C | C | C | C | C |
| | P | P | P | P | P | P | P | P | P | P | P | P | P | P | P |
| | 1 | 2 | 3 | 4 | 5 | 1 | 2 | 3 | 4 | 5 | 1 | 2 | 3 | 4 | 5 |
| CT¹ | 17 | 16 | 17 | 12 | 16 | 18 | 20 | 19 | 16 | 17 | 20 | 23 | 22 | 11 | 13 |
| GT² | 37 | 36 | 38 | 33 | 45 | 40 | 45 | 40 | 40 | 45 | 60 | 63 | 64 | 36 | 29 |
| TFT³ | 72 | 72 | 76 | 59 | 79 | 78 | 99 | 98 | 79 | 77 | 120 | 142 | 123 | 60 | 40 |
| T10⁴ | 175 | 174 | 181 | 171 | 174 | 175 | 174 | 181 | 171 | 174 | 176 | 175 | 179 | 184 | 191 |
| AD⁵ | 3.5 | 3 | 3.5 | 4.5 | 3.5 | 3.5 | 3 | 3 | 4 | 3 | 3 | 3.5 | 4 | 5 | 5 |
| FR⁶ | 1 | 1 | 1 | 5 | 5 | 1 | 1 | 1 | 5 | 5 | 1 | 1 | 2 | 5 | 5 |
| BD⁷ | 4.5 | 4.5 | 5 | 3 | 3 | 4 | 4.5 | 5 | 4 | 3.5 | 5 | 4 | 4.5 | 1 | 5 |
| | C | C | C | C | C | R | R | R | R | R | C | C | C | C | C |
| | P | P | P | P | P | C | C | C | C | C | C | C | C | C | C |
| | 1 | 2 | 3 | 4 | 5 | 1 | 2 | 3 | 4 | 5 | 1 | 2 | 3 | 4 | 5 |
| CT¹ | 18 | 26 | 26 | 13 | 13 | 19 | 18 | 18 | 15 | 18 | 29 | 30 | 26 | 11 | 13 |
| GT² | 55 | 60 | 70 | 35 | 27 | 41 | 40 | 42 | 45 | 48 | 69 | 70 | 74 | 38 | 29 |
| TFT³ | 110 | 130 | 130 | 55 | 40 | 83 | 107 | 110 | 82 | 74 | 135 | 180 | 170 | 61 | 44 |
| T10⁴ | 172 | 175 | 175 | 185 | 191 | 179 | 176 | 179 | 170 | 173 | 173 | 174 | 176 | 182 | 190 |
| AD⁵ | 3 | 2 | 3 | 4 | 5 | 3.5 | 3.5 | 3.5 | 4.5 | 3.5 | 2.5 | 3 | 3 | 4 | 5 |
| FR⁶ | 1 | 11.5 | 4.55 | 1 | 1 | 1 | 5 | 5 | 2 | 1 | 1 | 5 | 5 | | |
| BD⁷ | 3 | 4.5 | 4 | 5 | 3 | 4.5 | 4.5 | 5 | 3 | 3 | 3 | 3 | 4.5 | 2 | 4 |

¹CT (sec): Cream Time, Time at which reacting mixture discolors and starts to rise.
²GT (sec): Gel Time, Time at which cross links are formed and foam starts to harden. Foam forms treads upon inserting and extracting a stick into the core.
³TFT (sec): Tack Free Time, Time at which surface is dry and does no longer adhere upon touching.
⁴T10 (° C.): Core temperature after 10 minutes.
⁵AD (rated 1 (bad) to 5 (good)): Adhesion of foam to box.
⁶FR (rated 1 (bad) to 5 (good)): Friability of foam skin.
⁷BD (rated 1 (bad) to 5 (good)): Bottom Disturbances.

TABLE 5

| | 21 days aging at 21° C. | | | | | 21 days aging at 50° C. | | | | | 21 days aging at 50° C. | | | | | 31 days aging at 21° C. | | | | |
|---|---|---|---|---|---|---|---|---|---|---|---|---|---|---|---|---|---|---|---|---|
| | R | R | R | R | R | R | R | R | R | R | C | C | C | C | C | C | C | C | C | C |
| | P | P | P | P | P | P | P | P | P | P | P | P | P | P | P | P | P | P | P | P |
| | 1 | 2 | 3 | 4 | 5 | 1 | 2 | 3 | 4 | 5 | 1 | 2 | 3 | 4 | 5 | 1 | 2 | 3 | 4 | 5 |
| CT¹ | 18 | 16 | 19 | 15 | 17 | 16 | 19 | 20 | 15 | 18 | 23 | 25 | 22 | 11 | 11 | 24 | 26 | 26 | 8 | 10 |
| GT² | 42 | 46 | 46 | 50 | 53 | 41 | 43 | 48 | 43 | 48 | 60 | 76 | 70 | 36 | 30 | 54 | 55 | 68 | 30 | 25 |
| TFT³ | 73 | 82 | 97 | 84 | 76 | 60 | 86 | 108 | 68 | 70 | 188 | 150 | 160 | 60 | 41 | 75 | 141 | 154 | 48 | 33 |
| T10⁴ | 176 | 176 | 179 | 173 | 183 | 179 | 179 | 180 | 177 | 183 | 183 | 175 | 175 | 185 | 190 | 187 | 179 | 179 | 187 | 194 |
| AD⁵ | 3 | 3 | 4 | 4.5 | 3 | 2.5 | 3 | 3.5 | 4 | 4.5 | 3 | 3 | 3 | 4.5 | 5 | 3 | 3 | 3.5 | 4 | 5 |
| FR⁶ | 1 | 1 | 1 | 5 | 5 | 1 | 1 | 1 | 5 | 5 | 1 | 1 | 1 | 5 | 5 | 2 | 1 | 1 | 5 | 5 |
| BD⁷ | 4.5 | 4 | 3.5 | 4.5 | 3 | 4 | 4.5 | 4 | 3 | 3.5 | 3.5 | 3.5 | 4 | 4 | 4.5 | 3 | 4 | 3 | 3 | 4.5 |
| | R | R | R | R | R | R | R | R | R | R | C | C | C | C | C | C | C | C | C | C |
| | C | C | C | C | C | C | C | C | C | C | C | C | C | C | C | C | C | C | C | C |
| | 1 | 2 | 3 | 4 | 5 | 1 | 2 | 3 | 4 | 5 | 1 | 2 | 3 | 4 | 5 | 1 | 2 | 3 | 4 | 5 |
| CT¹ | 16 | 17 | 22 | 15 | 18 | 25 | 29 | 35 | 16 | 18 | 30 | 39 | 60 | 12 | 10 | 23 | 24 | 27 | 7 | 10 |
| GT² | 44 | 48 | 53 | 50 | 51 | 60 | 77 | 148 | 48 | 50 | 96 | 110 | 160 | 38 | 20 | 51 | 60 | 67 | 31 | 25 |
| TFT³ | 81 | 120 | 135 | 65 | 76 | 210 | 223 | 255 | 76 | 72 | 300 | 600 | 600 | 60 | 28 | 117 | 140 | 162 | 47 | 33 |
| T10⁴ | 180 | 178 | 178 | 172 | 183 | 175 | 178 | 179 | 175 | 186 | 183 | 175 | 175 | 180 | 191 | 173 | 179 | 174 | 187 | 192 |
| AD⁵ | 3 | 3.5 | 4 | 3 | 4 | 3 | 3 | 2 | 3 | 4 | 2 | 1 | 2 | 5 | 5 | 2.5 | 3 | 3.5 | 4 | 5 |
| FR⁶ | 1 | 1 | 1 | 5 | 5 | 1 | 1 | 1 | 5 | 5 | 1 | 1 | 1 | 5 | 5 | 2 | 1 | 1 | 5 | 5 |
| BD⁷ | 3.5 | 4 | 4 | 3 | 3 | 4 | 4 | 3 | 3 | 3 | 4 | 3 | 3 | 3 | 4 | 3 | 4 | 4 | 3 | 4.5 |

¹CT (sec): Cream Time, Time at which reacting mixture discolors and starts to rise.
²GT (sec): Gel Time, Time at which cross links are formed and foam starts to harden. Foam forms treads upon inserting and extracting a stick into the core.
³TFT (sec): Tack Free Time, Time at which surface is dry and does no longer adhere upon touching.
⁴T10 (° C.) Core temperature after 10 minutes.
⁵SD (rated 1 (bad) to 5 (good)): Adhesion of foam to box.
⁶FR (rated 1 (bad) to 5 (good)): Friability of foam skin.
⁷BD (rated 1 (bad) to 5 (good)): Bottom Disturbances.

TABLE 6

| | | | | | 59 days | | | | | | | | | | | | | | | |
|---|---|---|---|---|---|---|---|---|---|---|---|---|---|---|---|---|---|---|---|---|
| | 59 days aging at | | | | aging | | | 59 days aging at | | | | | | | | | | | | |
| | 21° C. | | | | at 50° C. | | | 21° C. | | | | | 59 days aging at 50° C. | | | | | | | |
| | R | R | R | R | R | R | R | R | R | R | C | C | C | C | C | C | C | C | C | C |
| | P | P | P | P | P | P | P | P | P | P | P | P | P | P | P | P | P | P | P | P |
| | 1 | 2 | 3 | 4 | 5 | 1 | 2 | 3 | 4 | 5 | 1 | 2 | 3 | 4 | 5 | 1 | 2 | 3 | 4 | 5 |
| CT¹ | 20 | 25 | 22 | 15 | 17 | 16 | 19 | 23 | 12 | 18 | 21 | 19 | 25 | 8 | 13 | 32 | 35 | 30 | 13 | 13 |
| GT² | 52 | 55 | 51 | 43 | 50 | 40 | 46 | 57 | 39 | 45 | 55 | 60 | 66 | 30 | 33 | 76 | 79 | 90 | 33 | 31 |
| TFT³ | 76 | 80 | 82 | 67 | 65 | 60 | 74 | 105 | 62 | 68 | 90 | 150 | 160 | 47 | 44 | 150 | 224 | 300 | 56 | 42 |
| T10⁴ | 186 | 182 | 183 | 179 | 190 | 177 | 185 | 176 | 179 | 187 | 174 | 178 | 179 | 183 | 192 | 183 | 175 | 179 | 182 | 188 |
| AD⁵ | 3 | 3 | 3 | 3 | 4 | 3 | 3 | 3 | 3 | 3 | 3 | 2 | 3 | 4 | 3 | 3 | 3 | 3 | 4 | 5 |
| FR⁶ | 3 | 3 | 2 | 5 | 5 | 3 | 1 | 2 | 4 | 5 | 3 | 1 | 1 | 5 | 5 | 3 | 2 | 1 | 5 | 5 |
| BD⁷ | 4 | 5 | 4 | 3 | 3 | 3 | 4 | 4 | 3 | 3 | 4 | 5 | 4 | 4 | 3 | 3 | 4 | 3 | 3 | 4 |
| | R | R | R | R | R | R | R | R | R | R | C | C | C | C | C | C | C | C | C | C |
| | C | C | C | C | C | C | C | C | C | C | C | C | C | C | C | C | C | C | C | C |
| | 1 | 2 | 3 | 4 | 5 | 1 | 2 | 3 | 4 | 5 | 1 | 2 | 3 | 4 | 5 | 1 | 2 | 3 | 4 | 5 |
| CT¹ | 19 | 24 | 20 | 16 | 16 | 25 | 40 | 60 | 16 | 17 | 25 | 27 | 32 | 10 | 10 | 40 | 70 | 75 | 10 | 13 |
| GT² | 45 | 49 | 56 | 45 | 49 | 94 | 116 | 150 | 40 | 50 | 65 | 70 | 80 | 35 | 27 | 120 | 180 | 197 | 37 | 30 |
| TFT³ | 90 | 180 | 150 | 67 | 66 | 240 | 300 | 600 | 75 | 71 | 150 | 230 | 300 | 52 | 35 | 360 | 600 | 600 | 55 | 40 |
| T10⁴ | 176 | 180 | 181 | 176 | 187 | 175 | 170 | 180 | 174 | 185 | 186 | 178 | 180 | 179 | 193 | 183 | 189 | 179 | 182 | 190 |
| AD⁵ | 4 | 3 | 3 | 3 | 4 | 3 | 3 | 2 | 3 | 3 | 3 | 3 | 3 | 5 | 5 | 2 | 2 | 1 | 5 | 5 |
| FR⁶ | 1 | 2 | 1 | 5 | 5 | 1 | 1 | 1 | 5 | 5 | 2 | 1 | 2 | 5 | 5 | 1 | 1 | 1 | 5 | 5 |
| BD⁷ | 5 | 5 | 4 | 3 | 3 | 4 | 4 | 3 | 3 | 3 | 3 | 3 | 4 | 2 | 2 | 3 | 4 | 2 | 2 | 3 |

¹CT (sec): Cream Time, Time at which reacting mixture discolors and starts to rise.
²GT (sec): Gel Time, Time at which cross links are formed and foam starts to harden. Foam forms treads upon inserting and extracting a stick into the core.
³TFT (sec): Tack Free Time, Time at which surface is dry and does no longer adhere upon touching.
⁴T10 (° C.) Core temperature after 10 minutes.
⁵AD (rated 1 (bad) to 5 (good)): Adhesion of foam to box.
⁶FR (rated 1 (bad) to 5 (good)): Friability of foam skin.
⁷BD (rated 1 (bad) to 5 (good)): Bottom Disturbances.

The polyol composition of the present invention has increased storage stability in the presence of water due to the reduced levels of polyester polyols in the composition.

Such increased storage stability makes it possible to reduce (1) the amount of VOC from volatile blowing agents by using water for the isocyanate-water reaction, (2) the amine catalyst levels and (3) the levels of physical blowing agents.

The EO diols/polyols increase the solubility of the physical blowing agents, especially pentane, thereby increasing storage stability with pentane while allowing better control of the foaming process.

Rigid polyisocyanurate foams produced from the polyol composition of the present invention contain significantly lower levels of volatile materials, thus reducing or eliminating the VOC impact on the environment while maintaining superior fire retardant performance of current isocyanurate foams and other product performance requirements that are currently standard in the industry.

What is claimed is:

1. A polyol composition comprising
(a) from about 15 to about 70 percent by weight of a first polyol comprising an ethylene oxide polyol having a functionality of from about 2 to about 8 and a molecular weight of from about 350 to 800,
(b) from about 5 to about 70 percent by weight of at least one second polyol selected from aliphatic, cycloaliphatic, aromatic and heterocyclic polyols; and
(c) from 0 to about 80 percent by weight of a polyester polyol, if there is only one second polyol.

2. The polyol composition of claim 1 wherein the first polyol is derived substantially from the addition of ethylene oxide to an initiator having a functionality of from about 2 to about 8.

3. The polyol composition of claim 1 wherein the first polyol is derived from the addition of only ethylene oxide (100% EO) to the initiator.

4. The polyol composition of claim 1 wherein the first polyol is an ethylene oxide diol having a molecular weight of from about 350 to about 800.

5. The polyol composition of claim 4 wherein the first polyol is an ethylene oxide diol having a molecular weight of from about 400 to about 700.

6. The polyol composition of claim 1 wherein the ethylene oxide polyol is present in an amount of at least 80 weight percent by weight of the total polyol.

7. The polyol composition of claim 1 wherein the first polyol comprises from about 80 to about 100 weight percent ethylene oxide and from 0 to about 20 weight percent propylene oxide.

8. The polyol composition of claim 1 further comprising from 0 to about 80 percent by weight of a polyester polyol.

9. The polyol composition of claim 1 further comprising an aromatic polyol in an amount of from 15 to 70 weight percent by weight of total polyol.

10. The polyol composition of claim 1 further comprising a halogenated polyol.

11. The polyol composition of claim 1 further comprising a propylene oxide-based polyether polyol.

12. The polyol composition of claim 9 wherein the aromatic polyol is a polyester polyol.

13. The polyol composition of claim 9 wherein the aromatic polyol is a Novolac-initiated polyether polyol.

14. The polyol composition of claim 2 comprising at least 80% ethylene oxide.

15. The polyol composition of claim 3 wherein 20 percent of the ethylene oxide is substituted with propylene oxide (PO).

16. A polyisocyanurate composition having an isocyanate index of from about 180 to about 450 and comprising the reaction product of a polyisocyanate and a polyol composition comprising a high concentration of ethylene oxide having a functionality of from about 2 to about 8.

17. A rigid polyisocyanurate foam comprising the polyisocyanurate composition of claim 1.

18. A process for making a polyisocyanurate foam which comprises reacting a polyisocyanate with the polyol composition of claim 1 in the presence of a trimerization catalyst.
